(19) United States
(12) Patent Application Publication
(10) Pub. No.: US 2026/0330155 A1
(43) Pub. Date: Oct. 22, 2026

(54) System and Method for Adapting Content Translations

(71) Applicant: The Toronto-Dominion Bank, Toronto (CA)

(72) Inventors: Mohamed ABBAS, Jersey City, NJ (US); Angela CHOO, Ottawa (CA); Anil Stewart BAKHLE, Guelph (CA); Prerak Bhavnesh TRIVEDI, Toronto (CA); Mya Ella CERTOSSI, Kitchener (CA)

(73) Assignee: The Toronto-Dominion Bank, Toronto (CA)

(21) Appl. No.: 19/182,084

(22) Filed: Apr. 17, 2025

(51) Int. Cl. G06F 40/58; G06F 40/284; G06F 40/295

(52) U.S. Cl. CPC G06F 40/58; G06F 40/284; G06F 40/295

(57) ABSTRACT

System, method and device for adapting content translations. The method includes storing an ontology associated with a domain, the ontology comprising a plurality of levels of information related to the domain and obtaining an input from a user interface, the input comprising content to be translated for the user interface. The method also includes processing the content in the input (e.g., using natural language processing) to determine keywords or phrases associated with the domain, mapping the determined keywords or phrases to one of the plurality of levels in the ontology, and selecting a translation of the content from a plurality of translations according to the mapped level in the ontology. The method includes providing a response in the user interface comprising the selected translation.

### TECHNICAL FIELD

The following relates generally to translating content and, more particularly, to adapting such translated content.

### BACKGROUND

Enterprises often find challenges communicating effectively with users of their platforms, systems and services when those users have varying levels of knowledge, experience or exposure to their domain. This can be exacerbated when there is a language barrier across different languages and cultures. This can lead to misunderstandings, reduced user confidence in the systems, and can create errors when consuming content provided by the enterprise, e.g., in an application or service.

### BRIEF DESCRIPTION OF THE DRAWINGS

Embodiments will now be described with reference to the appended drawings wherein:

FIG. 1 is a schematic diagram of an example computing environment.

FIG. 2 illustrates a process workflow executed by a translation engine in the computing environment.

FIG. 3a illustrates a content processing stage in the process workflow.

FIG. 3b illustrates a content extraction stage in the process workflow.

FIG. 3c illustrates a translation output stage in the process workflow.

FIG. 3d illustrates a continuous learning stage in the process workflow.

FIGS. 4a and 4b are user interfaces that illustrate dynamic translation outputs.

FIG. 5 is a block diagram of an example configuration for the translation engine.

FIG. 6 is a block diagram of an example configuration for an enterprise system.

FIG. 7 is a block diagram of an example configuration of a client device.

FIG. 8 is a flow chart illustrating example operations that may be performed in adapting content translations.

FIG. 9 is a flow chart illustrating example operations that may be performed in obtaining contextual information for performing an ontology mapping.

FIG. 10 is a flow chart illustrating example operations that may be performed in utilizing a context extraction module to obtain the contextual information.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Current translation systems are found to lack the ability to adapt to domain-specific terminology or to tailor terminology down to the user's specific level of understanding and cultural context. There exist various challenges with language and cultural barriers to using text-based communication, messaging and user interface (UI) tools and applications when a customer base is widely diverse. Moreover, difficulties can arise in generating clear machine translations based on the variety of translations that are possible (e.g., selecting the best translation from numerous options). There may also be difficulties encountered in refining training data into a system that includes various layers of granularity in a different language and doing so in real time without the model becoming onerously large or difficult to maintain.

The following describes a system for translating content associated with particular “domains”. A domain, as used herein, refers to any collective body of knowledge, skills, experience or association of ideas, expertise or organization or hierarchy of content. This may include domains associated with a particular type of technology (e.g., for technical support related to a product or service), financial understanding (e.g., related to a financial product or service), medical or healthcare knowledge (e.g., related to medical or health related inquiries), etc. For such domains, the level of knowledge or expertise or exposure to the themes, ideas, specifications, metrics, etc. can vary and thus may be categorized into a number of levels (e.g., expert, knowledgeable, familiar, unaware, etc.).

The following describes a translation tool or engine designed to reduce language barriers between an entity such as an enterprise and their employees and a client or customer conversing with that entity whose native language may be different. The translation engine may use advanced translation technology for transcription, translation, and text-to-speech conversion as well as language processing technology to provide near real-time or real-time translation of spoken conversations. The engine may be deployed to assist with general inquiries and discussions where various levels of understanding may exist.

The engine can provide both standard translation and an adaptive translation methodology that dynamically adjusts the complexity of domain-specific terminology and concepts based on the user's detected domain literacy level, language, and cultural background. It may combine real-time language translation with intelligent simplification or elaboration of domain-specific concepts, ensuring clear communication regardless of the user's expertise.

According to one aspect, a computing system for adapting content translations is provided. The computing system includes a processor, and a memory coupled to the processor. The memory stores computer executable instructions that when executed by the processor cause the computing system to store an ontology associated with a domain, the ontology comprising a plurality of levels of information related to the domain; obtain an input from a user interface, the input comprising content to be translated for the user interface; process the content in the input to determine keywords or phrases associated with the domain; map the determined keywords or phrases to one of the plurality of levels in the ontology; select a translation of the content from a plurality of translations according to the mapped level in the ontology; and provide a response in the user interface comprising the selected translation.

In certain example embodiments, the system is configured to obtain context associated with a user of the user interface and use the context in determining the level in the ontology.

In certain example embodiments, the context comprises a conversation history in the user interface, the input being provided in the conversation history.

In certain example embodiments, the plurality of levels in the ontology are associated with a corresponding level of complexity for information in the domain.

In certain example embodiments, the content in the input is processed using natural language processing (NLP).

In certain example embodiments, the NLP comprises at least one of: tokenization, part-of-speech tagging, or named entity recognition focused on the domain.

In certain example embodiments, the content in the input is processed using a large language model (LLM).

In certain example embodiments, the LLM is prompted by the computing system based on the determined keywords or phrases.

In certain example embodiments, at least one of the plurality of translations of the content is obtained by prompting an LLM.

In certain example embodiments, the system is further configured to feed the response to a continuous learning module to continuously train a model.

In certain example embodiments, the mapping comprising using a model.

In certain example embodiments, the selected translation is selected at least in part considering at least one of a regional dialect, a literacy competence, and a domain-related competence.

In certain example embodiments, the translation is selected dynamically in real-time as the content is provided to the user interface.

In certain example embodiments, multiple portions of content are dynamically translated into multiple corresponding translated portions during a messaging exchange with an entity via the user interface.

In another aspect, there is provided a method for adapting content translations. The method is implemented by a computing system and includes storing an ontology associated with a domain, the ontology comprising a plurality of levels of information related to the domain; obtaining an input from a user interface, the input comprising content to be translated for the user interface; processing the content in the input to determine keywords or phrases associated with the domain; mapping the determined keywords or phrases to one of the plurality of levels in the ontology; selecting a translation of the content from a plurality of translations according to the mapped level in the ontology; and providing a response in the user interface comprising the selected translation.

In certain example embodiments, the method further includes obtaining context associated with a user of the user interface and using the context in determining the level in the ontology.

In certain example embodiments, the context comprises a conversation history in the user interface, the input being provided in the conversation history.

In certain example embodiments, the plurality of levels in the ontology are associated with a corresponding level of complexity for information in the domain.

In certain example embodiments, the content in the input is processed using natural language processing.

In another aspect, there is provided a computer readable medium storing computer-executable instructions for adapting content translations. The computer readable medium stores computer-executable instructions that, when executed by a computing system, cause the computing system to store an ontology associated with a domain, the ontology comprising a plurality of levels of information related to the domain; obtain an input from a user interface, the input comprising content to be translated for the user interface; process the content in the input to determine keywords or phrases associated with the domain; map the determined keywords or phrases to one of the plurality of levels in the ontology; select a translation of the content from a plurality of translations according to the mapped level in the ontology; and provide a response in the user interface comprising the selected translation.

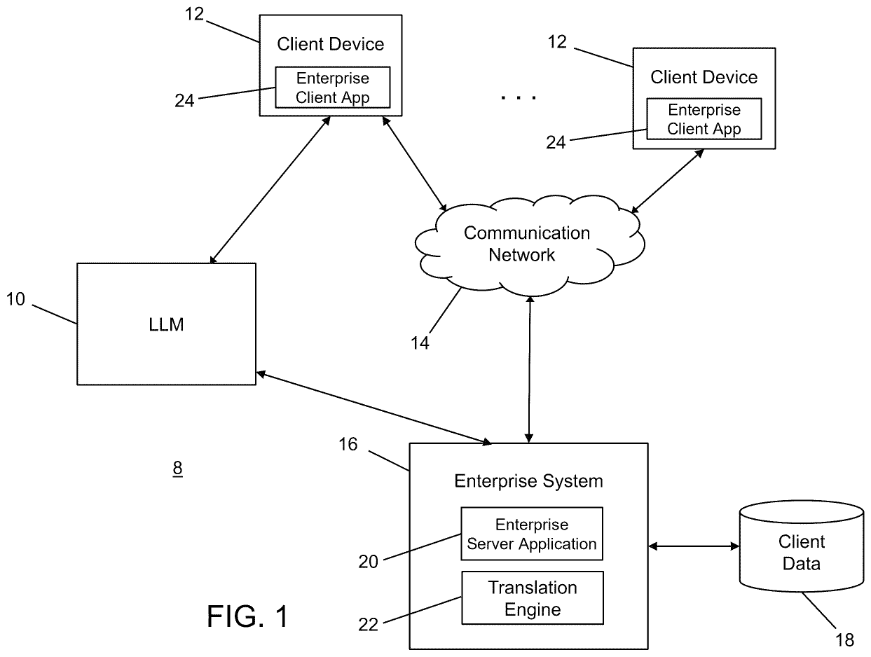

Referring now to the figures, FIG. 1 illustrates an example of a computing environment 8. In one aspect, the computing environment 8 may include one or more client devices 12, and one or more communications networks 14 connecting the components of the computing environment 8. The client devices 12 may include or otherwise have access to an LLM 10 via the communication network 14.

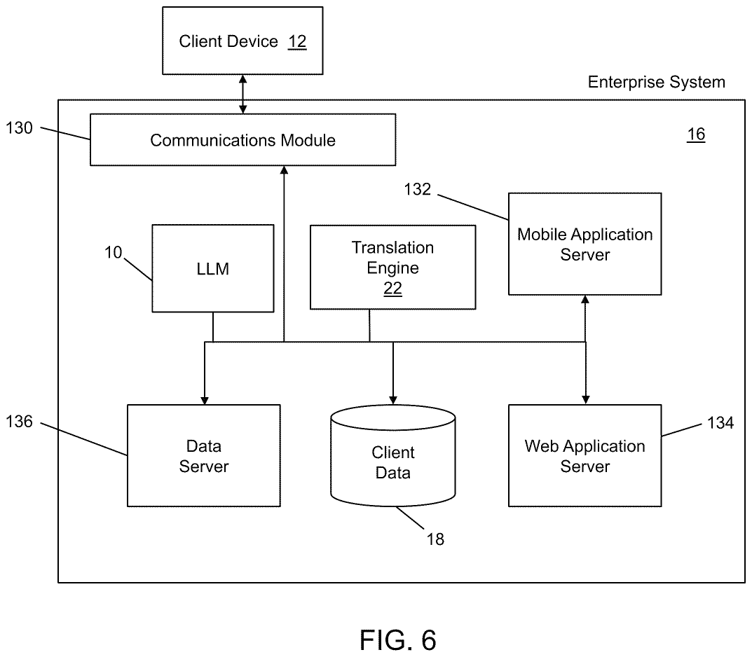

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 6 below for additional details. The enterprise system 16 includes, at least in part, an enterprise server application 20, which may be referred to as the server application 20 herein for brevity. The enterprise server application 20 may include or, as shown in FIG. 1, have access to, a translation engine 22. The translation engine 22 enables the enterprise server application 20 to obtain and provide multiple levels or details of content (e.g., translated content), for a UI provided by the enterprise client app 24, as described more fully below.

The enterprise system 16 also includes or otherwise has access to a datastore for storing client data 18. The enterprise system 16 may include other datastores not shown in FIG. 1. The data associated with a user can include client profile data that may be mapped to corresponding data for that user. The corresponding data may include any data associated with a domain. The domain, as noted above, may be associated with any particular service or utility being provided by the enterprise system 16 and need not be limited to any particular examples herein. For example, a financial institution may have an enterprise system 16 whose client data 18 includes financial data. It can be appreciated that such financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the enterprise system 16 and/or LLM 10 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. In the example shown in FIG. 1, the client device includes an enterprise client application (app) 24, which may also be referred to herein as a client app 24 for brevity.

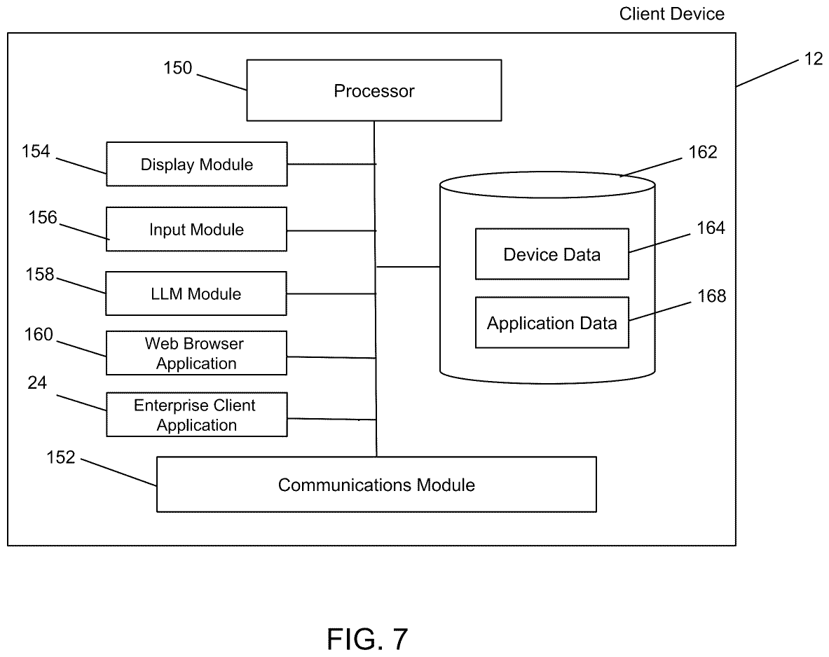

For example, the user may use client device 12 to engage and interface with a mobile or web-based financial (banking) application which uses or incorporates subsystems of the enterprise system 16, discussed further below. The client devices 12 in this example show a client app 24 but may also include a browser 160 (see FIG. 7) for accessing web-based applications.

The client devices 12 can access information within the enterprise system 16 and/or from the LLM 10, or another remote computing environment associated with the enterprise system 16 in a variety of ways. For example, the client device 12 can access the enterprise system 16 via a web-based application, or a dedicated application such as the client app 24, which corresponds to the enterprise server application 20. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be migrated into digital and remote computing environments.

The enterprise system 16 may include both on-premises and remote computing assets provided by a remote computing environment-not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft TM Azure TM data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)^{TM} suite, etc. The computing resources can also include hardware resources, such as access to processing capability of server devices (e.g., cloud computing), and so forth.

The LLM 10 is shown as a separate entity in FIG. 1 for illustrative purposes and, in other configurations, may be part of or otherwise integrated into/with the enterprise system 16 (e.g., see FIG. 6). As shown in FIG. 1, the LLM 10 may be coupled to or in communication with the enterprise server application 20, via the enterprise system 16, to permit a user of a client device 12 to obtain a response related to a request that is submitted via the enterprise client app 24 and directed through the enterprise server application 20.

Referring again to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

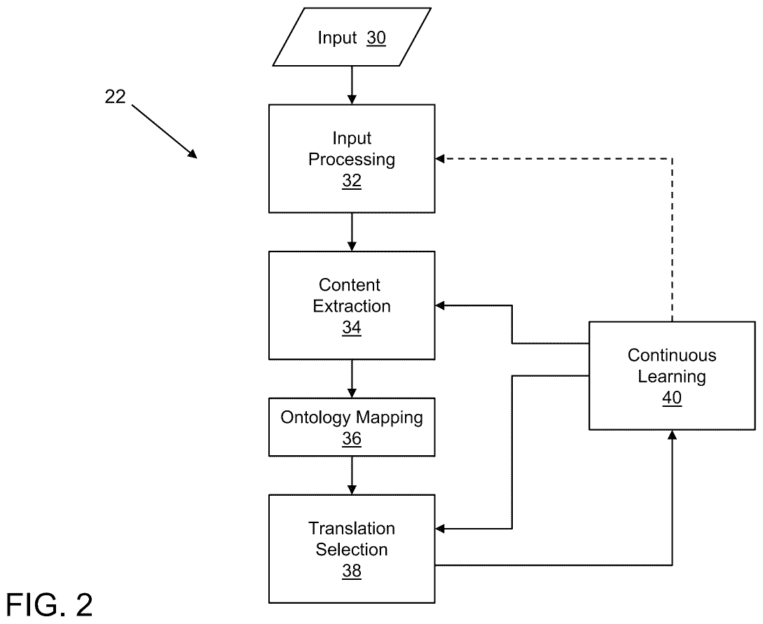

Turning now to FIG. 2, one example of a configuration for the translation engine 22 is shown. In this configuration, functional blocks are shown to illustrate stages in the operation of the translation engine 22. It can be appreciated that the term “translation” as used herein may refer to the translation of one language to another language (e.g., Spanish to English or French to English) as well as the translation of a concept from a relatively lower or simpler version to a relatively higher or more complex version (or vice versa) based on a determined expertise or knowledge base of a user.

In this example, the translation engine 22 begins by obtaining (e.g., pulling or accepting) an input 30. The input 30 may be provided to the translation engine 22 by the client app 24, enterprise server application 20 or some other utility, service or function to have the translation engine 22 process the input 30 as described herein.

For example, the input 30 may be provided by a chat UI or a voice recognition system, which may include an inquiry, question, request, or other conversational content that can be processed and interpreted by the translation engine 22 in order to provide a response or subsequent message that includes a “translated” portion or an entire translation or selectively modifies a particular reply according to the content of the input 30 and other data such as metadata, historical data, user data, application data, etc.

The input 30 is consumed by an input processing stage 32, which performs initial processing such as tokenization, part-of-speech tagging and/or named entity recognition focused on terms that relate to a domain associated with the enterprise system 16 and/or application 20, e.g., technical domain, financial domain, medical/health domain, utility/industrial domain, etc. That is, the input 30 is processed to break down what the user has said, asked, requested or otherwise provided to determine import or key words, phrases, concepts, questions, ideas, requests, commands, and identify any domain-specific terms that can be used to determine an appropriate response based on the domain and the user's knowledge and expertise, understanding and language-specific needs.

The processed input that is output by the input processing stage 32 may then be processed by a content extraction stage 34. The content extraction stage 34 uses the processed input along with metadata about the user, if applicable a current conversation history, historical conversations or interactions with the system (e.g., prior uses of the client app 24, etc. The enterprise system 16 may also utilize its controlled access to the client data 18 to determine that user's literacy or expertise related to the domain. For example, a financial institution may have client data 18 that can be used to determine how sophisticated the user's knowledge is related to a financial topic such as lending, trading, or general banking. This may be determined from analyzing the client data 18 or by keeping metrics associated with users that rank or score their knowledge. Similar analyses may be done for other domains such as technical expertise, health-related knowledge, etc.

The extracted content and any recognized domain-specific terms may be mapped onto an ontology that relates to the domain (e.g., a financial ontology) in an ontology mapping stage 36. This allows the translation engine 22 to understand the domain-specific concepts being discussed and the relevancy to the conversation. The ontology mapping stage 36 may be constructed in advance and may evolve over time based on the particular domain. The ontology may direct the translation engine 22 to a corpus of information and data having different levels of expertise or knowledge associated therewith (also referred to herein as different levels of “translation” (whether for language, literacy, both or otherwise), in order to allow the translation engine 22 to select the most appropriate response to the input 30. For example, the input processing stage 32 and/or content extraction stage 34 may determine both a literacy level and a dialect or other language-related metric that can be used to communicate with the user in the most appropriate language, dialect and at a level of understanding that is suitable to them. Moreover, the language and dialect may be used to determine, from the ontology, if certain terms are more appropriate than others (e.g., effective interest rates versus annual percentage rates). For example, consider a user that has migrated from Turkey to the United States, where she visits a financial institution to talk about building her credit. She learns how to obtain and build credit in the United Stages, and throughout the conversation hears the term “Credit Bureau”, but is unfamiliar with the terminology. The ontology maps to “Kredit Kayit Burosu” in a Turkish dialect, which is the first and only credit bureau in Turkey.

The extracted context and ontology mapping may then be used in a translation selection stage 38 to choose the most appropriate translation. As indicated above, the “translation” may include both content and language translations according to the context, user history, client data 18, determined literacy, and any other factors available to the translation engine 22 at that time. The translation engine 22 may therefore customize and curated the output or response provided to the input 30 that is relevant to the user's literacy, language, dialect and general understanding and historical context around the topic, domain and specific conversation.

The translation engine 22 may include or otherwise have access to a continuous learning stage 40. As the engine 22 generates outputs, the continuous learning stage 40 may observe literacy behaviors and outcomes (e.g., follow-up questions showing higher or lower literacy) and resolution of inquiries (e.g., via a chat that ends up with a satisfactory result) to, over time, refine the context extraction stage 34 and translation selection stage 38 to improve the outputs. The continuous learning stage 40 may utilize available machine learning and other AI tools to update ML or statistical models, etc. The continuous learning stage 40 may also provide feedback to the input processing stage 32 and, while not shown, may be used to separately improve and refine the ontology mapping stage 36, particularly where the ontology mapping stage 36 is proprietary and not based on a known industry standard.

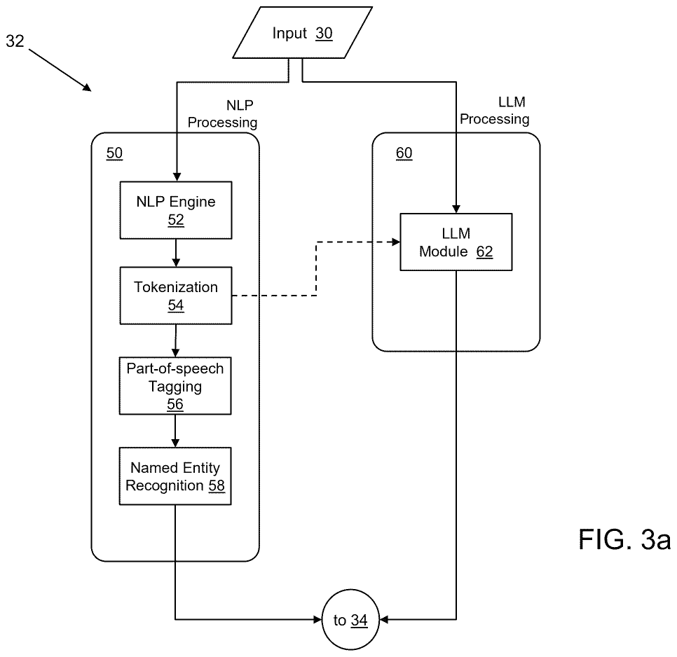

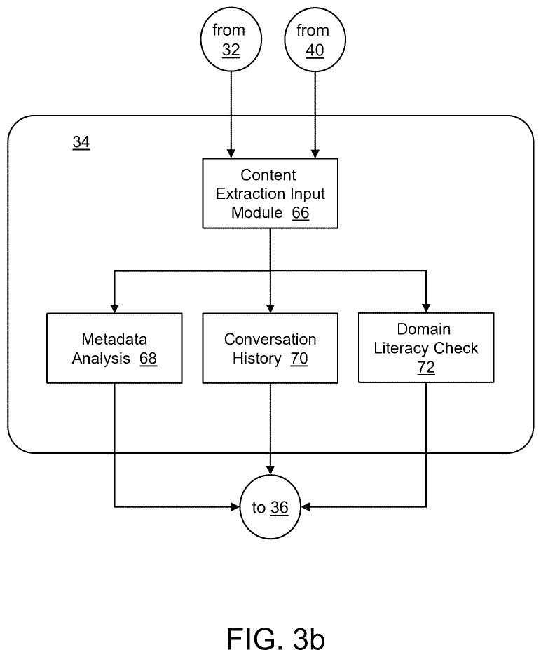

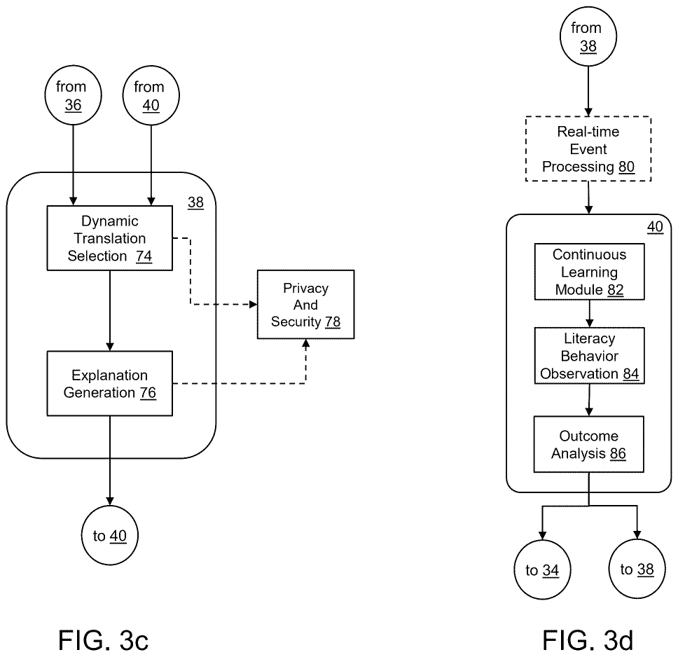

FIGS. 3a, 3b, 3c, and 3d provide additional detail concerning example configurations for implementing the stages 34-40 shown in FIG. 2.

Referring to FIG. 3a, an example of a configuration for the input processing stage 32 is shown. In this example, the input processing stage 32 may include both NLP processing 50 and LLM processing 60. The LLM processing 60 may utilize the LLM 10, which is separate from the enterprise system 16 in the configuration shown in FIG. 1 but may alternatively be a local LLM 10 as shown in FIG. 6. Whether provided by a third party LLM 10 or internal LLM 10, an LLM module 62 may be used to generate tokens and interface with the LLM 10 to prompt the LLM 10 to perform at least some of the initial input processing stage 32. The NLP processing 50 may utilize an NLP engine 52 to perform NLP on the content of the input 30. The NLP processing 50 may also perform tokenization 54, which can be utilized additionally by the LLM module 62 to generate prompts for the LLM 10. In this example, the NLP processing 50 may include modules for part-of-speech tagging 56 and named entity recognition 58 by way of example. It can be appreciated that the NLP processing 50 may incorporate other modules for performing other NLP-related processing, including, for example, voice-to-text or speech-to-text processing to enable a voice input 30 to be processed for content extraction stage 34. The results of the NLP processing 50 and LLM processing 60 are fed to the context extraction stage 34.

A configuration for implementing the content extraction stage 34 is shown in FIG. 3b. Inputs from the input processing stage 32 and continuous learning stage 40, where applicable, may be fed to a context extraction input module 66 to gather the relevant processed inputs for performing various analyses for content extraction. In this example, a metadata analysis 68, a conversation history 70 and domain literacy check 72 are examples of such analyses that may be performed to associate any available data and information to specific content in the input 30 that was identified in the input processing stage 32 and extracted using the module 66. The results of the content extraction stage 34 may be used to feed the ontology mapping stage 36, which was described above.

Referring now to FIG. 3c, the output of the ontology mapping stage 36 and, where applicable, feedback from the continuous learning stage 40, may be used to perform a dynamic translation selection stage 74 in the translation selection stage 38. The dynamic translation selection stage 74 is used to identify language, dialect and literacy for the domain to instruct an explanation generation stage 76 to generate an output. The output of the modules 74, 76 may be fed to a privacy and security stage 78 to apply and privacy or security controls, e.g., to mask or redact any data or prevent the release of certain sensitive information. The output may also be provided to the continuous learning stage 40, which is shown in FIG. 3d.

As shown in FIG. 3d, the continuous learning stage 40 may feed the output to a continuous learning module 83, literacy behavior observation module 84 and an outcome analysis module 86 to evaluate the results of the translation engine's operations to continuously refine, for example, the content extraction stage 34 and/or the translation selection stage 38. FIG. 3d also illustrates an optional real-time event processing stage 80, which enables the enterprise system 16 to couple the translation engine 22 to internal systems for event monitoring and event processing, e.g., using a Kafka-type real-time processing infrastructure. For example, the continuous learning stage 40 may subscribe to topics related to the translation engine 22 and its components to consume data for continuous learning, providing a further integration of the translation engine 22 into the enterprise system 16.

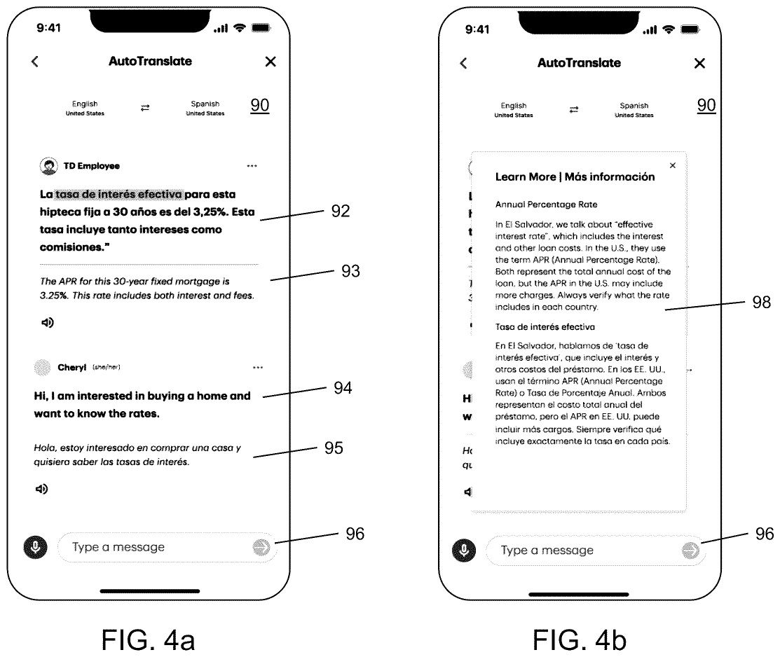

FIGS. 4a and 4b illustrate use cases for adopting the translation engine 22 to assist in responding to a query or to otherwise translate content within a client app 24. For the examples shown in FIGS. 4a and 4b consider an example where, when translating “APR”, the translation engine 22 considers the specific mortgage product being discussed, the user's previous interactions and inferred knowledge level, and the targeted language's explanation of AP. As shown in FIG. 4a, the translation engine UI 90 enables a user “Cheryl” to ask a question in Spanish at 95, that is translated to English at 94 using an input box 96. The translation engine 22 can provide a response in both languages 93, 92, which considers whether to use “APR”. However, when selecting “APR” or some other input in the UI 90, the translation engine 22 may provide additional information 98 in both languages to provide additional details based on the literacy of this user, who may not be familiar with the term “APR”. As shown in FIG. 4b, in this case the translation engine 22 provides context relative to the user's familiarity with El Salvador, based on metadata or client data 18. It can be appreciated that the translation engine 22 may provide either or both the outputs shown in FIGS. 4a and 4b, and such different levels of detail and understanding may be selectable by the user or automatically determined by the translation engine 22.

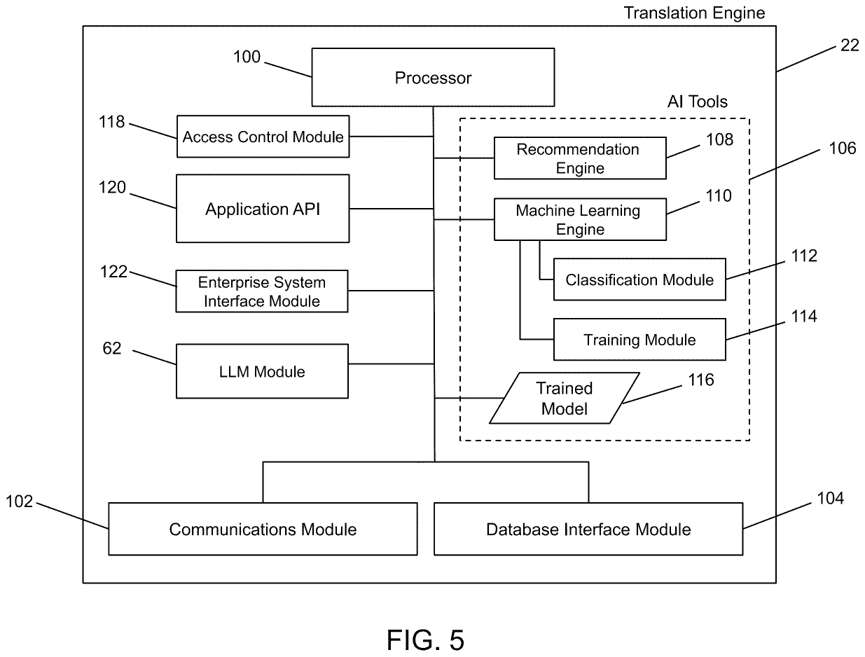

In FIG. 5, an example configuration of the translation engine 22 is shown. In certain embodiments, the translation engine 22 may include one or more processors 100, a communications module 102, and a database interface module 104 for interfacing with the datastores and other data sources, to retrieve, modify, and store (e.g., add) data. Communications module 102 enables the translation engine 22 to communicate with one or more other components of the computing environment 8, such as client device 12, enterprise system 16 or LLM 10, via a bus or other communication network, such as the communication network 14. While not delineated in FIG. 5, the translation engine 22 includes at least one memory or memory device that can include a tangible and non-transitory computer-readable medium having stored therein computer programs, sets of instructions, code, or data to be executed by processor 100.

FIG. 5 illustrates examples of modules, tools and engines stored in memory on the translation engine 22 and executed by the processor 100. It can be appreciated that any of the modules, tools, and engines shown in FIG. 5 may also be hosted externally and be available to the translation engine 22, e.g., via the communications module 102. In the example embodiment shown in FIG. 5, the translation engine 22 includes a suite or set of AI tools 106. The AI tools 106 include or otherwise have access to a recommendation engine 108, a machine learning engine 110, a classification module 112, a training module 114, and at least one trained model 116. The translation engine 22 also includes an access control module 118 and an application programming interface (API), referred to in FIG. 5 as an application API 120 to enable the translation engine 22 to interface with the enterprise server application 20. The translation engine 22 also includes an enterprise system interface module 122 to enable it to communicate with the enterprise system 16 and the LLM module 62 to enable the translation engine 22 and the AI tools 106 to access the LLM 10 (e.g., third party LLM for generating responses to requests, etc.).

The recommendation engine 108 is used by the AI tools 106 of the translation engine 22 to generate one or more recommendations for the translation engine 22 and/or a client device 12 that is/are related to generating translated content that utilizes the ontology mapping 36. It may be noted that a recommendation as used herein may refer to a prediction, suggestion, inference, association or other recommended identifier that can be used to generate a suggestion, notification, command, instruction or other data that can be viewed, used or consumed by the translation engine 22. The recommendation engine 108 can access data and information and apply one or more inference processes to generate the recommendation(s). The recommendation engine 108 may utilize or otherwise interface with the machine learning engine 110 to both classify data currently being analyzed to generate a suggestion or recommendation, and to train classifiers using data that is continually being processed and accumulated by the translation engine 22. That is, the recommendation engine 108 can learn segmentation outcomes, risk tiers and risk assessments, utilize confusion matrices, etc., and revise and refine classifications, rules or other analytics-related parameters over time. For example, the trained model 116 can be updated and refined using the training module 114 as client devices 12 and/or the translation engine 22 interact with the client app 24 and/or enterprise server application 20, during various interactions to improve the AI/ML parameters and understanding of how certain behaviors relate to, for example, domain literacy.

The machine learning engine 110 may also perform operations that classify the segmentation and other data (e.g., client data 18) in accordance with corresponding classifications parameters, e.g., based on an application of one or more machine learning algorithms to the data or groups of the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the decision-related content or content being analyzed, the recommendation engine 108 may further process each element of the content to identify, and extract, a value characterizing the corresponding one of the classification parameters, e.g., based on an application of one or more additional machine learning algorithms to each of the elements of the decision-related content. By way of example, the additional machine learning algorithms may include, but are not limited to, an adaptive NLP algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. The LLM module 62 may be used to additionally access and prompt the LLM 10 for creating generative content. Classification parameters may be stored and maintained using the classification module 112, and training data may be stored and maintained using the training module 114.

The trained model 116 may also be created, stored, refined, updated, re-trained, and referenced by the translation engine 22 (e.g., by way of the AI tools 106) to determine associations between actions and outcomes associated with behavior, and suitable responses or actions, and/or content related thereto. Such associations can be used to generate recommendations or suggestions for improving decisions being made, e.g., for determining when and how to act on such activity and behaviors to improve the content selection by the translation engine 22.

In some instances, classification data stored in the classification module 112 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between decision parameters and outcomes (e.g., approve or deny), and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 110 may perform operations that classify each of the discrete elements of decision-related content as a corresponding one of the classification parameters, e.g., as obtained from classification data stored by the classification module 112.

The outputs of the machine learning algorithms or processes may then be used by the recommendation engine 108 to generate one or more suggested recommendations, instructions, commands, notifications, rules, or other instructional or observational elements that can be presented to the AI tools 106. The AI tools 106 may be used by any one or more of the operations shown in FIGS. 2 and 3a-3d described herein. Similarly, the AI tools 106 may use the LLM module 62 to access third party sources such as GPT-type services that use their own LLMs 10.

In FIG. 6, an example configuration of an enterprise system 16 is shown. The enterprise system 16 includes a communications module 130 that enables the enterprise system 16 to communicate with one or more other components of the computing environment 8, such as the LLM 10 and/or client device(s) 12, via a bus or other communication network, such as the communication network 14. While not delineated in FIG. 6, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 6 illustrates examples of servers and datastores/databases operable within the enterprise system 16. It can be appreciated that any of the components shown in FIG. 6 may also be hosted externally and be available to the enterprise system 16, e.g., via the communications module 130. In the example embodiment shown in FIG. 6, the enterprise system 16 includes one or more servers to provide access to client data 18, e.g., for making decisions related to a particular client or entity (e.g., user of client device 12). Exemplary servers include a mobile application server 132, a web application server 134 and a data server 136. The enterprise system 16 also includes the LLM 10 and the translation engine 22 in this example. It can be appreciated that, as discussed above, the LLM 10 may be a third party LLM 10 and that more than one LLM 10 may be utilized by the translation engine 22 and/or enterprise system 16.

Although not shown in FIG. 6, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 18.

Mobile application server 132 supports interactions with a mobile application installed on client device 12. Mobile application server 132 can access other resources of the enterprise system 16 to carry out requests made by, and to provide content and data to, a mobile application on client device. In certain example embodiments, mobile application server 132 supports a mobile banking application to provide payments from one or more accounts of user, among other things.

Web application server 134 supports interactions using a website accessed by a web browser application running on the client device. It can be appreciated that the mobile application server 132 and the web application server 134 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 18 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

It will be appreciated that only certain modules, applications, tools and engines are shown in FIGS. 5 and 6 for ease of illustration and various other components would be provided and utilized by the LLM 10, enterprise system 16, and translation engine 22, as is known in the art.

In FIG. 7, an example configuration of a client device 12 is shown. In certain embodiments, the client device 12 may include one or more processors 150, a communications module 152, and a data store 162 storing device data 164 and application data 166. Communications module 152 enables the client device 12 to communicate with one or more other components of the computing environment 8, such as the enterprise system 16 and/or LLM 10, via a bus or other communication network, such as the communication network 14. While not delineated in FIG. 7, the client device 12 includes at least one memory or memory device that can include a tangible and non-transitory computer-readable medium having stored therein computer programs, sets of instructions, code, or data to be executed by processor 150. FIG. 7 illustrates examples of modules and applications stored in memory on the client device 12 and executed by the processor 150. It can be appreciated that any of the modules and applications shown in FIG. 7 may also be hosted externally and be available to the client device 12, e.g., via the communications module 152.

In the example embodiment shown in FIG. 7, the client device 12 includes a display module 154 for rendering GUIs and other visual outputs on a display device such as a display screen, and an input module 156 for processing user or other inputs received at the client device 12, e.g., via a touchscreen, input button, transceiver, microphone, keyboard, etc. The client device 12 may also include an LLM module 158, which may take the form of a customized app, plug-in, widget, or software component provided by the LLM 10 for use by the client device 12 to use in communicating with the LLM 10. Similarly, the client device 12 may include the enterprise system client application 24 provided by the enterprise system 16. The client device 12 in this example embodiment also includes a web browser application 160 for accessing Internet-based content, e.g., via a mobile or traditional website. The data store 162 may be used to store device data 164, such as, but not limited to, an IP address or a MAC address that uniquely identifies client device 12 within environment 8. The data store 162 may also be used to store application data 168, such as, but not limited to, login credentials, user preferences, cryptographic data (e.g., cryptographic keys), etc.

It will be appreciated that only certain modules, applications, tools and engines are shown in FIGS. 2-7 for ease of illustration and various other components would be provided and utilized by the LLM 10, client device 12, translation engine 22, and enterprise system 16 as is known in the art.

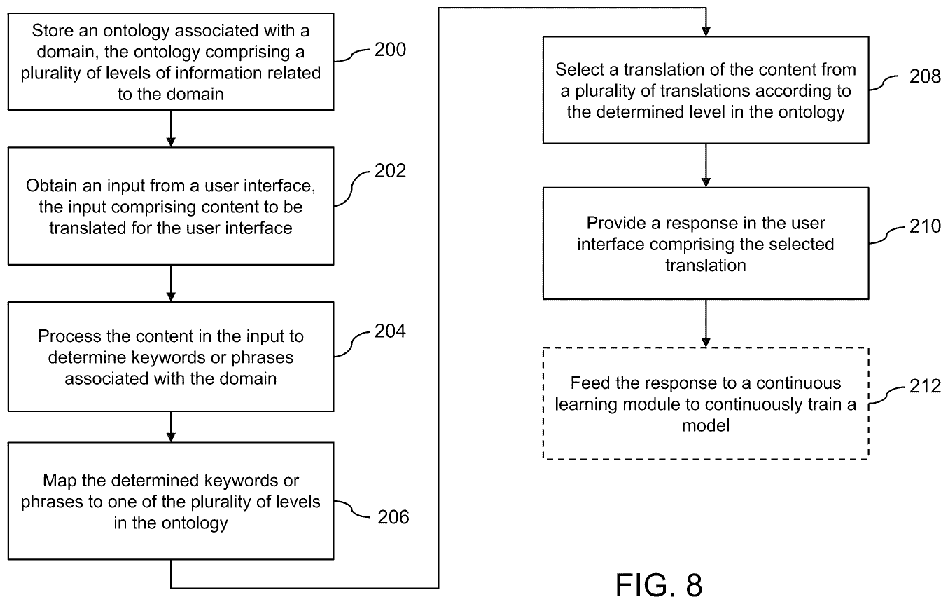

Referring now to FIG. 8, a flow chart illustrates operations that may be performed in adapting content translations. At block 200, the translation engine 22 may store an ontology associated with a domain, e.g., a domain relevant to the enterprise system 16 and the client app 24. The ontology includes a number of levels of information related to the domain. These levels may include levels of literacy or indications of a particular level of detail or sophistication for which the translation engine 22 can use to select a particular translation.

At block 202, the translation engine 22 receives an input 30 from a UI. The input 30 includes content to be translated for the UI, based on either or both language or literacy related metrics. At block 204, the translation engine 22 processes the content in the input 30 to determine keywords or phrases associated with the domain, e.g., financial terms or concepts.

At block 206, the translation engine 22 maps the determined keywords or phrases to one of the plurality of levels in the ontology to enable the translation engine 22 to select a translation of the content at block 208. This may include selecting from one of multiple translations of the content with different levels of detail or specificity, for example, based on the determined level in the ontology. At block 210, the translation engine 22 provides a response in the UI, which includes the selected translation.

Optionally, at block 212, the response may be fed to the continuous learning stage 40 to continuously train a model, e.g., in any one of the stages shown in FIG. 2.

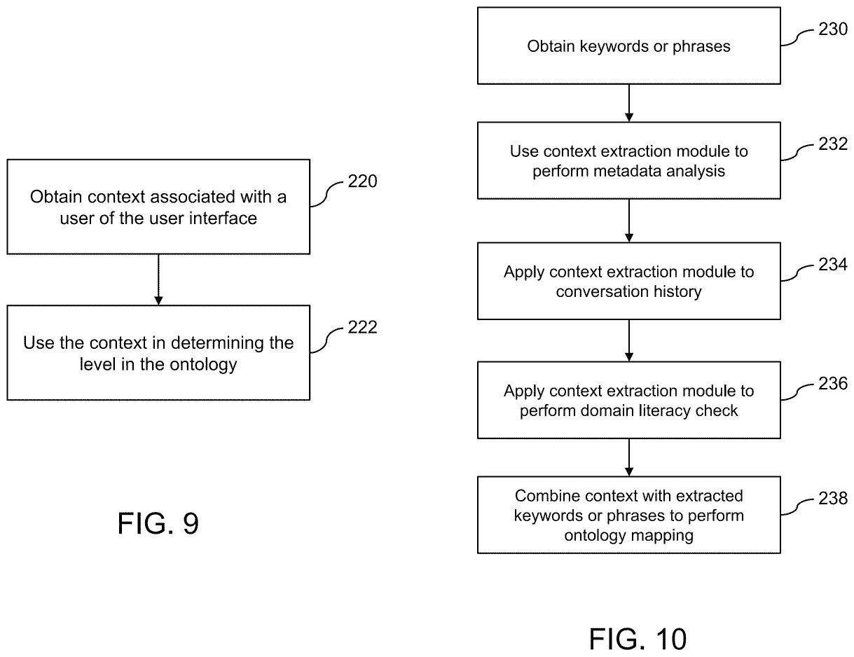

FIG. 9 is a flow chart illustrating example operations that may be performed in obtaining contextual information for performing an ontology mapping. At block 220, the content extraction stage 34 may obtain context associated with a user of the UI, e.g., using the client data 18, conversation histories, the current conversation, etc. At block 222, the context may be used in determining the level in the ontology which may be used to select a particular literacy or relevance level, or a dialect or language-related metric for selecting the content to be returned to the user.

FIG. 10 is a flow chart illustrating example operations that may be performed in utilizing a context extraction module to obtain the contextual information. At block 230, keywords or phrases are obtained and at block 232, the context extraction module 34 may be used to perform a metadata analysis 68. Similarly, at block 234, the content extraction module 34 may be applied to a conversation history 70 and/or to perform a domain literacy check 72 at block 236.

At block 238, the context may be combined with the extracted keywords or phrases to perform the ontology mapping 36.

There are many technical and user-related advantages to adopting the proposed system. For example, in the financial domain, the system improves customer understanding of complex financial products and service, enhances customer experience by providing clear, context-appropriate explanations; reduces miscommunication and potential financial mistakes due to language barriers; increases customer confidence in making informed financial decisions; and supports financial inclusion by making banking services more accessible to nonnative speakers. Similar advantages can be found with other domains such as technical or technology-related services.

The system can also expand market reach to diverse linguistic communities, reduce customer service costs by minimizing misunderstandings and follow-up inquiries, enhance brand reputation as an innovator in customer-centric banking technology, improve regulatory compliance by ensuring accurate communication of financial terms, and increase customer trust and loyalty through improved communication and service.

The system also provides a unique integration of advanced NLP, financial domain knowledge, and real-time contextual analysis, provides potential for significant improvement in customer service and satisfaction, has applicability across various financial products and services, and aligns with growing trends in personalized banking.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A computing system for adapting content translations, the computing system comprising:
a processor; and
a memory coupled to the processor, the memory storing computer executable instructions that when executed by the processor cause the computing system to:
store an ontology associated with a domain, the ontology comprising a plurality of levels of information related to the domain;
obtain an input from a user interface, the input comprising content to be translated for the user interface;
process the content in the input to determine keywords or phrases associated with the domain;
map the determined keywords or phrases to one of the plurality of levels in the ontology;
select a translation of the content from a plurality of translations according to the mapped level in the ontology; and
provide a response in the user interface comprising the selected translation.

2. The computing system of claim 1, wherein the system further comprises instructions to:
obtain context associated with a user of the user interface; and
use the context in determining the level in the ontology.

3. The computing system of claim 2, wherein the context comprises a conversation history in the user interface, the input being provided in the conversation history.

4. The computing system of claim 1, wherein the plurality of levels in the ontology are associated with a corresponding level of complexity for information in the domain.

5. The computing system of claim 1, wherein the content in the input is processed using natural language processing (NLP).

6. The computing system of claim 4, wherein the NLP comprises at least one of:
tokenization, part-of-speech tagging, or named entity recognition focused on the domain.

7. The computing system of claim 1, wherein the content in the input is processed using a large language model (LLM).

8. The computing system of claim 7, wherein the LLM is prompted by the computing system based on the determined keywords or phrases.

9. The computing system of claim 1, wherein at least one of the plurality of translations of the content is obtained by prompting an LLM.

10. The computing system of claim 1, wherein the system further comprises instructions to:
feed the response to a continuous learning module to continuously train a model.

11. The computing system of claim 1, wherein the mapping comprising using a model.

12. The computing system of claim 1, wherein the selected translation is selected at least in part considering at least one of a regional dialect, a literacy competence, and a domain-related competence.

13. The computing system of claim 1, wherein the translation is selected dynamically in real-time as the content is provided to the user interface.

14. The computing system of claim 13, wherein multiple portions of content are dynamically translated into multiple corresponding translated portions during a messaging exchange with an entity via the user interface.

15. A method for adapting content translations, the method being implemented by a computing system and comprising:
storing an ontology associated with a domain, the ontology comprising a plurality of levels of information related to the domain;
obtaining an input from a user interface, the input comprising content to be translated for the user interface;
processing the content in the input to determine keywords or phrases associated with the domain;
mapping the determined keywords or phrases to one of the plurality of levels in the ontology;
selecting a translation of the content from a plurality of translations according to the mapped level in the ontology; and
providing a response in the user interface comprising the selected translation.

16. The method of claim 15, further comprising:
obtaining context associated with a user of the user interface; and
using the context in determining the level in the ontology.

17. The method of claim 16, wherein the context comprises a conversation history in the user interface, the input being provided in the conversation history.

18. The method of claim 15, wherein the plurality of levels in the ontology are associated with a corresponding level of complexity for information in the domain.

19. The method of claim 15, wherein the content in the input is processed using natural language processing.

20. A non-transitory computer readable medium storing computer-executable instructions for adapting content translations, comprising computer-executable instructions that, when executed by a computing system, cause the computing system to:
store an ontology associated with a domain, the ontology comprising a plurality of levels of information related to the domain;
obtain an input from a user interface, the input comprising content to be translated for the user interface;
process the content in the input to determine keywords or phrases associated with the domain;
map the determined keywords or phrases to one of the plurality of levels in the ontology;
select a translation of the content from a plurality of translations according to the mapped level in the ontology; and
provide a response in the user interface comprising the selected translation.
